(19) United States
(12) Patent Application Publication
(10) Pub. No.: US 2010/0300035 A1
(43) Pub. Date: Dec. 2, 2010

(54) MOUNTING DEVICE FOR FRAMEWORKS AND METHOD

(76) Inventor: Edward W. Pither, Naples, FL (US)

Correspondence Address: EDWARD M. LIVINGSTON, PA, 963 TRAIL TERRACE DRIVE, NAPLES, FL, 34103, US

(21) Appl. No.: 12/472,641

(22) Filed: May 27, 2009

(51) Int. Cl. E04B 1/00; F16B 37/14

(52) U.S. Cl. 52/745.21; 411/372.6

(57) ABSTRACT

A mounting device (20) for frameworks is disclosed having a washer (2) having a sleeve (1) extending downward, which fits over the body (12) of a screw (5), and a cap (3) that is secured to the washer to conceal the screw head (8) of the screw from harmful elements. The length of the sleeve is equal to or slightly greater than the height of a hollow frame (6) being secured to a structure (7) so that the body of the screw is protected from coming into contact with any water or air. The sleeve also acts as a spacer in between the top of the aluminum frame and the structure to prevent over-tightening of the screw, thereby preventing dimpling a top surface of the frame.

### BACKGROUND OF THE INVENTION

This invention relates to mounting devices for frameworks, such as screened enclosures, hurricane shutters, etc., more particularly, a screw sleeve, washer and cap that protect screws used to construct frameworks and mount frameworks to structures from rain and other elements and a method for securing a framework to a structure.

Currently, many homes have frameworks, such as screened enclosures, hurricane shutters, etc., mounted thereto. Screened enclosures are used to protect patios and/or pools from insects and animals. These enclosures are constructed using aluminum frames which are secured to one another to form a framework and secured to structures, such as patios and houses, etc., using screws which are fastened through the aluminum frames into the structures and through aluminum frames to other aluminum frames. These screws are often made of carbonized steel or other metals which pose problems because the screws are exposed to outdoor elements, such as water, salt air and chemicals from pools, that cause the screw to rust. One solution has been to cover the screw in a protective coating, such as paint or a ceramic material. However, these protective coatings are often chipped and damaged during the installation process, thereby exposing the screw to harmful elements. A further problem is that some screw metals, such as stainless steel, create a chemical reaction when they come into direct contact with the aluminum frames resulting in the oxidation and corrosion of the aluminum frame. The effects caused by exposure to harmful elements and the direct contact of a screw with an aluminum frame arc not only unsightly but also weaken the structural integrity of the framework of the enclosure.

A further problem is that water and chemicals can find their way under aluminum frames mounted to patios through the screw hole in the frame and create a sauna effect inside of the hollow aluminum frame. This can cause the head of the screw as well as the body of the screw to rust at an accelerated rate and fail, thereby causing the aluminum frame to become detached from the patio. The failure of a screw in this manner can threaten the structural integrity of the screened enclosure, especially during storms with high winds.

An even further problem arises when installing enclosures. Installers often over-tighten screws into the concrete, thereby bending the aluminum frame creating an unsightly dimple in the frame where water can collect around the head of the screw and cause the screw to rust.

Therefore, a need exists for a mounting device which will protect a screw used for constructing frameworks and mounting frameworks to patios and other structures from elements, such as rain, salt, pool chemicals and contact with the aluminum frame and will prevent over-tightening of the screw, thereby preventing dimpling in the aluminum frame.

The relevant prior art includes the following references:

| Pat. No. | | Issue/ |
|---|---|---|
| (U.S. unless stated otherwise) | Inventor | Publication Date |
| DE202005008497 | Hergert et al. | Aug. 11, 2005 |
| DE102004007876 | Schlecker | Aug. 04, 2005 |
| EP1367269 | Aureyre et al. | Dec. 03, 2003 |
| 6,623,226 | Braun et al. | Sep. 23, 2003 |
| DE20217322 | Woerner | Feb. 20, 2003 |
| DE10031907 | Zahn | Jan. 10, 2002 |
| WO01/88386 | Schott | Nov. 22, 2001 |
| 6,318,927 | Schafer et al. | Nov. 20, 2001 |
| DE10039767 | Eberlein et al. | Jul. 26, 2001 |
| WO01/46598 | Muth | Jun. 28, 2001 |
| 4,437,804 | Fischer | Mar. 20, 1984 |

### SUMMARY OF THE INVENTION

The primary object of the present invention is to provide a mounting device for frameworks and method that protects a mounting screw from elements, such as rain, salt and pool chemicals.

Another object of the present invention is to provide a mounting device for frameworks and method that prevents a screw from coming into contact with a frame.

A further object of the present invention is to provide a mounting device for frameworks and method that seals the space between a screw head and a screw hole in the frame thereby preventing any water from entering the screw hole.

An even further object of the present invention is to provide a mounting device for frameworks that acts as a spacer thereby preventing over tightening of screws and dimpling in an aluminum frame.

The present invention fulfills the above and other objects by providing a mounting device having a non-metal washer, made out of a material such as nylon and a sleeve extending downward, which fits over the body of a screw and a cap that is secured to the washer to conceal the screw head of the screw from harmful elements. The length of the sleeve is equal to the height of a frame being secured to a structure, such as a patio, so that the body of the screw is protected from coming into contact with any water or air. In addition, the sleeve may be a bit longer than the height of the frame and tapered at the end to ensure a tight seal against the structure and the frame. The sleeve also acts as a spacer in between the top of the frame and the structure to prevent over-tightening of the screw, thereby preventing dimpling in the frame.

The washer and sleeve components of the device may be integrated or separate so that a user may use only a washer and a cap to protect the head of a screw being used to construct a frame work, mount an L-bracket to a structure or any other situation where a sleeve is not needed.

In an alternative embodiment, the head of a screw is encapsulated by a non-metal cap, made out of a material such as nylon, having a washer and sleeve that are all one piece and molded around the head and body of the screw.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed descriptions reference will be made to the attached drawings in which:

FIG. 1 is a side perspective plan exploded view of a mounting device of the present invention;

FIG. 2 is a side sectional view of a mounting device of the present invention being used to secure a frame to a structure;

FIG. 3 is a side partial sectional view of another embodiment of the mounting device of the invention being used to secure a L-bracket mounted a structure and a frame using a screw, washer and cap;

FIG. 4 is a front view of an alternative embodiment of the mounting device of the present invention having an integrated cap, washer and sleeve molded on a mounting screw;

FIG. 5 is a front view of an alternative embodiment of the mounting device of the present invention in which a washer and cap are a single piece molded around a screw head; and

FIG. 6 is a flow chart showing a method of using the mounting device of the present invention to secure a frame to a structure.

### DESCRIPTION OF THE PREFERRED EMBODIMENTS

For purposes of describing the preferred embodiment, the terminology used in reference to the numbered accessories in the drawings is as follows:
1. sleeve
2. washer
3. cap 13
4. fastening means
5. screw
6. frame
7. structure
8. screw head
9. L-bracket
10. interlocking ridge
11. inner surface of cap
12. screw body
13. drill hole through frame or L-bracket
14. drill hole into structure
15. place washer over screw
16. place sleeve over screw body
17. insert screw and sleeve into hole
18. fasten screw
19. secure cap to washer
20. mounting device

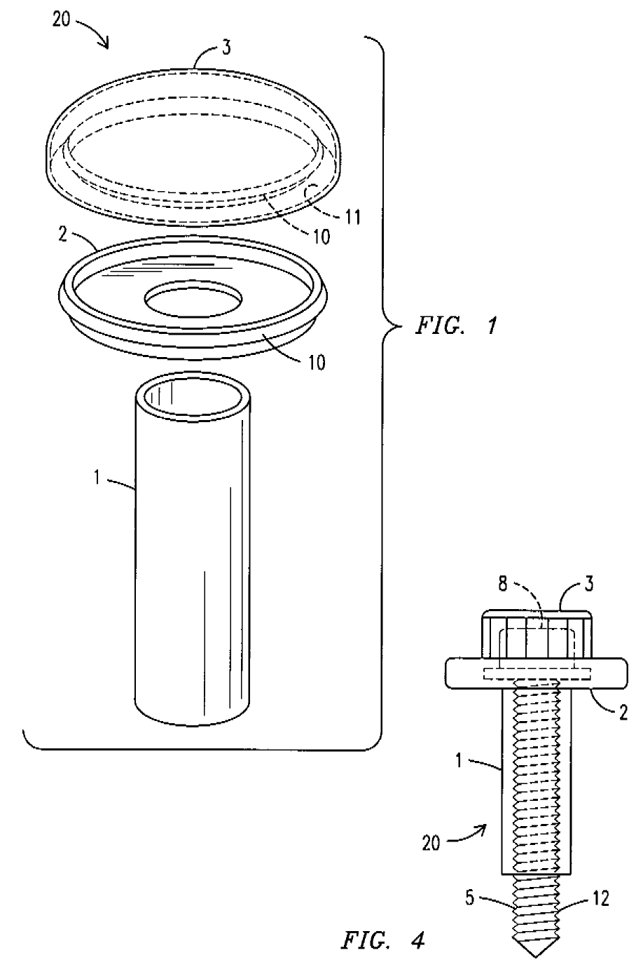

With reference to FIG. 1, a side perspective plan exploded view of a mounting device 20 of the present invention comprising a screw sleeve 1, a washer 2 and a cap 3 are shown. The sleeve 1, washer 2 and cap 3 are preferably made of a non-metal material such as nylon. The cap 3 may be secured to the washer 2 by a fastening means 4, such as interlocking ridges 10 located on the washer 2 and the inner surface 11 of the cap 3. The sleeve 1 is preferably tubular in shape to fit over a body 12 of a screw 5, as shown in FIG. 2. In addition, the washer 2 and sleeve 1 may be separate pieces, as shown here, or a single molded piece as shown in FIG. 4.

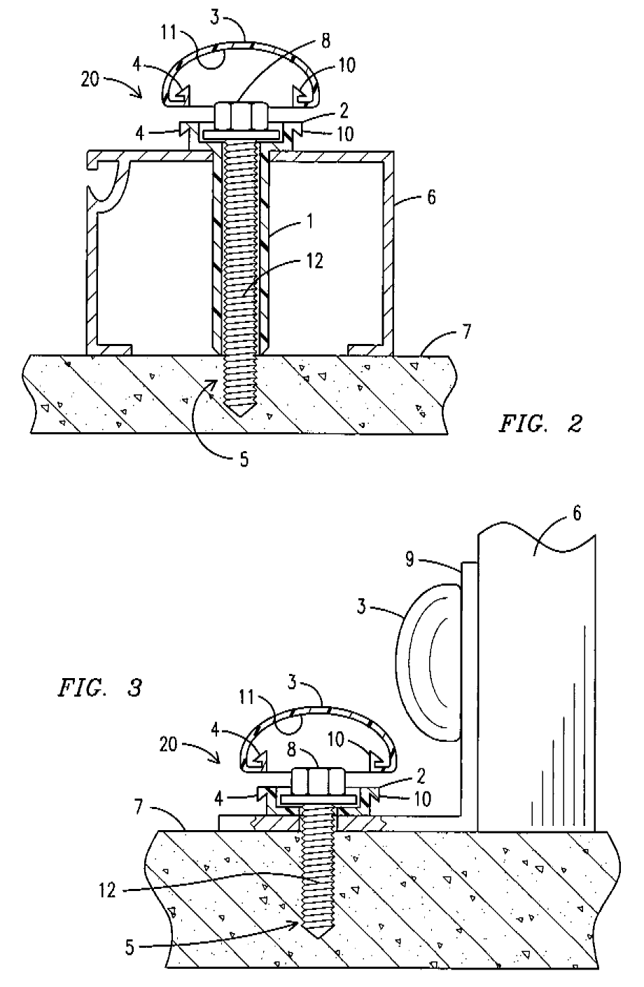

Now referring to FIG. 2, a side partial sectional view shows a frame 6 mounted to a structure 7, which is a concrete surface, using a screw 5 and the mounting device 20 having a screw sleeve 1, washer 2 and cap 3. The sleeve 1 extends downward from the washer 2 and fits over a body 12 of the screw 5. The cap 3 may be secured to the washer 2 by a fastening means 4, such as interlocking ridges 10 located on the washer 2 and the inner surface 11 of the cap 3. The length of the sleeve 1 is equal to the height of a frame 6 being secured to the structure 7 so that the body 12 of the screw 5 is protected from coming into contact with any water or air by a pressure seal formed between an upper inner surface of the frame 6 and the structure 7. The sleeve 1 may even be a bit longer than the height of the frame 6 and tapered at the end to ensure a tight seal against the structure 7 and the frame 6. The sleeve 1 also acts as a spacer between the upper inner surface of the aluminum frame 6 and the structure 7 to prevent over-tightening of the screw 5, thereby preventing dimpling in the frame 6. In addition, the washer 2 and sleeve 1 may be a single piece or separate pieces so that a user may have the option of using only a washer 2 and a cap 3 to protect the head 8 of a screw 5 being used to mount an l-bracket 9 and sleeve 1, as shown in FIG. 3.

Now referring to FIG. 3, a side partial sectional view of another embodiment of the mounting device 20 of the present invention used to secure a frame 6 is shown. A L-bracket 9 is secured to a structure 7, which is a concrete surface, and a screened enclosure frame 6 using a screw 5, a screw washer 2 and cap 3. The washer 2 creates a seal between the underside of the screw head 8 and the L-bracket 9. The cap 3 may be secured to the washer 2 by a fastening means 4, such as interlocking ridges 10 located on the washer 2 and the inner surface 11 of the cap 3. In addition to being aesthetically pleasing, the cap 3 along with the seal created by the washer protect the screw head 8 from harmful elements thereby preventing the screw head 8 from rusting.

Now referring to FIG. 4, a front view of an alternative embodiment of the mounting device 20 having a sleeve 1, washer 2 and cap 3 as a single piece molded around the screw body 12 and screw head 8 is shown.

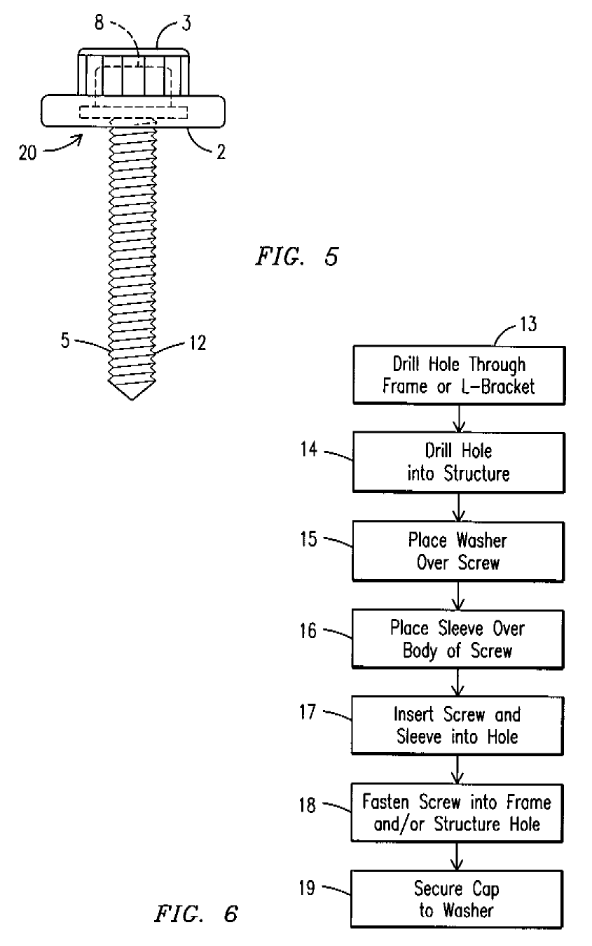

Now referring to FIG. 5, a front view of an alternative embodiment of the mounting device 20 without a sleeve is shown in which the washer 1 and cap 2 as a single piece molded around the screw head 8.

Finally, referring to FIG. 6, a flow chart showing a method for securing an enclosure to a structure using the mounting device of the present invention is shown. First, a hole is drilled through a frame or a L-bracket at a predetermined point 13. Then a hole is drilled into a structure at a predetermined point 14. Next, a washer is placed over a body of a screw 15. Then, a sleeve is place over said body of said screw 16. Next, said screw is placed into said hole drilled through the frame or L-bracket 17. Then, said screw is fastened into the hole drilled into the frame and/or the structure 18. Finally, a cap is secured onto said washer via a fastening means 19.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A mounting device for mounting a framework comprising:
a screw;
a washer that fits over a body of said screw; and
a cap that attaches to the washer by a fastening means and covers a head of the screw.

2. The mounting device for mounting a framework of claim 1 further comprising:
a sleeve that fits over and covers a portion of the body of the screw.

3. The mounting device for mounting a framework of claim 1 wherein:
said fastening means is at least one interlocking ridge.

4. The mounting device for mounting a framework of claim 2 wherein:
the fastening means is at least one interlocking ridge.

5. The mounting device for mounting a framework of claim 1 wherein:
said washer and cap are a single piece molded around the head of a screw.

6. The mounting device for mounting a framework of claim 2 wherein:
said washer and cap are a single piece molded around the head of a screw.

7. The mounting device for mounting a framework of claim 2 wherein:
said sleeve, washer and cap are a single piece molded around a screw head and screw body.

8. The mounting device for mounting a framework of claim 2 wherein:
said washer and sleeve are a single piece.

9. A mounting device for mounting a framework comprising:
a screw;
a washer that fits over a body of said screw;
a cap that attaches to the washer by a fastening means and covers a head of the screw; and
a sleeve that fits over and covers a portion of said body of said screw.

10. The mounting device for mounting a framework of claim 9 wherein:
said fastening means is at least one interlocking ridge.

11. The mounting device for mounting a framework of claim 9 wherein:
said washer and cap are a single piece molded around the head of a screw.

12. The mounting device for mounting a framework of claim 9 wherein:
said sleeve, washer and cap are a single piece molded around a screw head and screw body.

13. The mounting device for mounting a framework of claim 9 wherein:
said washer and sleeve are a single piece.

14. A method for securing a framework to a structure using a mounting device comprising a screw, washer, sleeve and cap comprising the steps of:
a. placing the washer over a body of the screw;
b. inserting the screw through a hole located in at least one frame; and
c. securing the cap onto said washer via a fastening means.

15. The method of claim 14 further comprising a step prior to step a of:
drilling a hole into a structure at a predetermined point;
drilling a hole through at least one frame at a predetermined location.

16. The method of claim 14 further comprising a step after step a of:
placing the sleeve over the body of the screw.

17. The method of claim 15 further comprising a step after step a of:
placing the sleeve over the body of the screw.

18. The method of claim 14 wherein:
the frame is an L-bracket.

19. The method of claim 14 further comprising a step after step b of:
fastening the screw into the at least one frame.

20. The method of claim 15 further comprising a step after step b of:
fastening the screw into the hole drilled into the structure.
